(19) United States
(12) Patent Application Publication
(10) Pub. No.: US 2008/0062169 A1
(43) Pub. Date: Mar. 13, 2008

(54) Method Of Enabling To Model Virtual Objects

(75) Inventors: Michael Heesemans, Eindhoven (NL); Galileo June Destura, Eindhoven (NL); Ramon Eugene Franciscus Van De Ven, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/572,927

(22) PCT Filed: Jul. 21, 2005
(86) PCT No.: PCT/IB05/52451

§ 371 Date: Jan. 30, 2007

(30) Foreign Application Priority Data
Aug. 2, 2004 (EP) 04103705.2

(51) Int. Cl. G06T 17/00

(52) U.S. Cl. 345/420; 345/424

(57) ABSTRACT

A data processing system has a display monitor for rendering a virtual object, and a touch screen for enabling a user to interact with the object rendered. The system is operative to enable the user to modify a shape of the object at a first location on the object. The shape is modified under control of a magnitude of a pressure registered at a second location on the touch screen substantially coinciding with the first location when viewed through the touch screen in operational use of the system.

### FIELD OF THE INVENTION

The invention relates to a data processing system with a display monitor for rendering a virtual object, and with a touch screen for enabling a user to interact with the object rendered. The invention further relates to a method and to control software for enabling to model a shape of a virtual object rendered on a display monitor having a touch screen.

### BACKGROUND ART

Video games, graphics games and other computer-related entertainment software applications have become increasingly more widespread, and are currently being used even on mobile phones. In multi-player games or applications, players use animated graphical representations, known as avatars, as their representatives in a virtual environment. Dedicated devices are being marketed for electronic pet toys, e.g., Tamaguchi: a rearing game, wherein the user has to take care of a virtual animal rendered on a display monitor.

The creation of virtual interactive worlds with graphics creatures and objects is an art form that does not lend itself well to being masterfully applied by a layperson, let alone by a child. Nevertheless, software applications that enable a layperson or a youngster to create such creatures and objects would be welcomed, as they help to give a person control over previously unattainable aspects of electronic worlds.

Modeling of an object in a virtual environment in a user-friendly and easily understood manner is discussed in US patent application publication US20020154113 (attorney docket US 018150) filed Apr. 23, 2001 for Greg Roelofs as application Ser. No. 09/840,796, entitled VIRTUAL ELEPHANT MODELING BY VOXEL-CLIPPING SHADOW-CAST and incorporated herein by reference. This patent document discloses making a graphics model of a physical object shaped as, e.g., an elephant, by using bitmap silhouettes of the physical model in different orientations to carve away voxels from a voxel block. This gives an intuitively simple tool to enable a user to create graphics representations of physical objects for use in, e.g., virtual environment and in video games.

US patent publication 2002/0089500 filed for Jennings et al. for SYSTEMS AND METHODS OF THREE-DIMENSIONAL MODELING, incorporated herein by reference, discloses systems and methods for modifying a virtual object stored within a computer. The systems and methods allow virtual object modifications that are otherwise computationally inconvenient. The virtual object is represented as a volumetric representation. A portion of the volumetric model is converted into an alternative representation. The alternative representation can be a representation having a different number of dimensions from the volumetric representations. A stimulus is applied to the alternative representation, for example by a user employing a force-feedback haptic interface. The response of the alternative representation to the stimulus is calculated. The change in shape of the virtual object is determined from the response of the alternative representation. The representations of the virtual object can be displayed at any time for the user. The user can be provided a force-feedback response. Multiple stimuli can be applied in succession. Multiple alternative representations can be employed in the system and method.

### SUMMARY OF THE INVENTION

The inventors propose a system or a method for enabling to create or shape a virtual model that can be used as an alternative to the known systems and methods discussed above, or in addition to the above systems and methods.

To this end, the inventors propose a data processing system with a display monitor for rendering a virtual object, and with a touch screen for enabling a user to interact with the object rendered. The system is operative to enable the user to modify a shape of the object at a first location on the object. The shape is modified under control of a magnitude of a pressure registered at a second location on the touch screen substantially coinciding with the first location when viewed through the touch screen in operational use of the system.

Note that the Jennings document referred to above neither teaches nor suggests using the touch screen as if this itself were to physically represent the surface of the object. In the invention, the object is manually shaped by the user through the user's applying a pressure to a certain location at the touch screen that corresponds or coincides with a specific part of the object's surface displayed. In Jennings, input devices such as a computer mouse, joystick or touch screen are being used as equivalent alternatives to interact with tools graphically represented through the user-interactive software application. By using the touch screen in the manner of the invention, gradations of shaping the object can be achieved simply by means of re-scaling (magnifying or reducing) the image of the object rendered on the display monitor. Further, as the touch screen physically represents the object, feedback to the user can be limited to visual feedback only as if he/she were molding a chunk of clay. For example, in an operational mode of the system, the object's shape continues to be modified only if the pressure, as registered by the touch screen, increases. Lowering the pressure at the same location leaves the shape as it was at the time of the maximum value of the pressure. That is, the shape responds to a change in pressure at a location perceived by the user to correspond and coincide with an image of the object, which provides for a direct and more intuitive user interface than the one used in Jennings.

Rendering the virtual object as if the corresponding physical object were put under proper illumination conditions may enhance the visual feedback. The resulting shadows and changes therein during user interaction with the virtual object are then similar to those experienced as if the user were handling the corresponding physical object in reality. In a further embodiment, the touch screen registers the user's hand already when approaching, so as to be able to generate an artificial shadow of the hand on the virtual object in order to enhance visual impressions.

Preferably, the system of the invention allows programming a relationship between the levels of deformation of the shape on one hand, and the magnitude of the applied pressure on the other hand. This can be used, e.g., to program or simulate the physical or material properties such as elasticity or rigidity of a physical object corresponding to the virtual object. Also, this relationship may take into account the scale of the image of the object. This is explained as follows. By definition, pressure is the force per unit of area. The force is applied by the user to an area of the touch screen having an order of magnitude of that of the surface of a fingertip. Upon re-scaling the object as displayed, the same force is applied to a larger or smaller area when mapped onto the object displayed. Accordingly, the virtual pressure applied to the virtual object depends on the scale at which it is being displayed. Therefore, above relationship may be programmable or programmed to take the scaling effects into account. Refinements may relate to, for example, providing a non-linear character to the relationship of pressure versus deformation in order to model the increasing resistance of physical materials to increasing compression.

Preferably, the system has provisions to enable the touch screen to be used for modeling the virtual object by pushing at the virtual object, as well as by pulling at the object. That is, the system has a further operational mode wherein the shape of the virtual object responds to a decrease of the pressure to the touch screen. For example, the user may increase the pressure at a certain location at a rate faster than a certain threshold. The system is programmed to interpret this as that the user wants to pull at the object, rather than push. Upon a gentle release of the pressure the object is deformed as if it were pulled, e.g., in the direction towards the user and at the location corresponding to the area at the touch screen where the user is touching the latter.

The invention also relates to a method of enabling to model a shape of a virtual object rendered on a display monitor having a touch screen. The shape is enabled to get modified at a first location on the object under control of a magnitude of a pressure registered at a second location on the touch screen substantially coinciding with the first location on the display monitor when viewed through the screen in operational use of the system. The method is relevant to, e.g., a service provider on the Internet, or to a multi-user computer game under control of a server that enables in the virtual world the kind of interaction discussed above with respect to the system and its features.

The invention may also be embodied in control software for use on a data processing system with a display monitor and a touch screen. The software allows the user interaction and use of the features described above.

### BRIEF DESCRIPTION OF THE DRAWING

The invention is explained in further detail, by way of example and with reference to the accompanying drawing wherein:

FIG. 1 is a block diagram of a system in the invention;

FIGS. 2-5 illustrate several embodiments of the invention;

FIG. 6 is a flow diagram illustrating a process in the invention; and

FIGS. 7-9 are diagrams illustrating reversal of the polarity of the deformation.

Throughout the figures, same reference numerals indicate similar or corresponding features.

### DETAILED EMBODIMENTS

FIG. 1 is a block diagram of a system 100 in the invention. System 100 comprises a display monitor 102, and a touch screen 104 arranged so that the user sees the images displayed on monitor 102 through screen 104. Touch screen 104 is capable of processing input data representative of the touch location relative to the screen as well as input data representative of a force or pressure that the user exerts on the touch screen in operational use. The user input in the form of a location where the user touches screen 104 corresponds with a specific location of the image displayed on monitor 102. System 100 further comprises a data processing sub-system 106, e.g., a PC or another computer, e.g., at a remote location and connected to monitor 102 and touch screen 104 via the Internet or a home network (not shown). Alternatively, above components 102-106 may be integrated together in a PC or a handheld device such as a cell phone, a PDA, or a touch-screen remote control. Sub-system 106 is operative to process the user input data and to provide the images under control of a software application 108. Sub-system 106 may comprise a remote server taking care of the data processing accompanying the intended deformations of the virtual object. Under circumstances this data processing may well be compute-intensive, e.g., in a real-time multi-user computer game or when relating to a sophisticated virtual object, and then is preferably delegated to a special server.

Touch screen 104 is configured to register both a touch location and a magnitude of the pressure applied to screen 104 when the user touches screen 104. This configuration allows the user input to be considered 3-dimensional: two coordinates that determine a position at the surface of screen 104 and a further coordinate perpendicular to screen 104 represented by a magnitude of the pressure of the touch. This is now being used in the invention to model a virtual object.

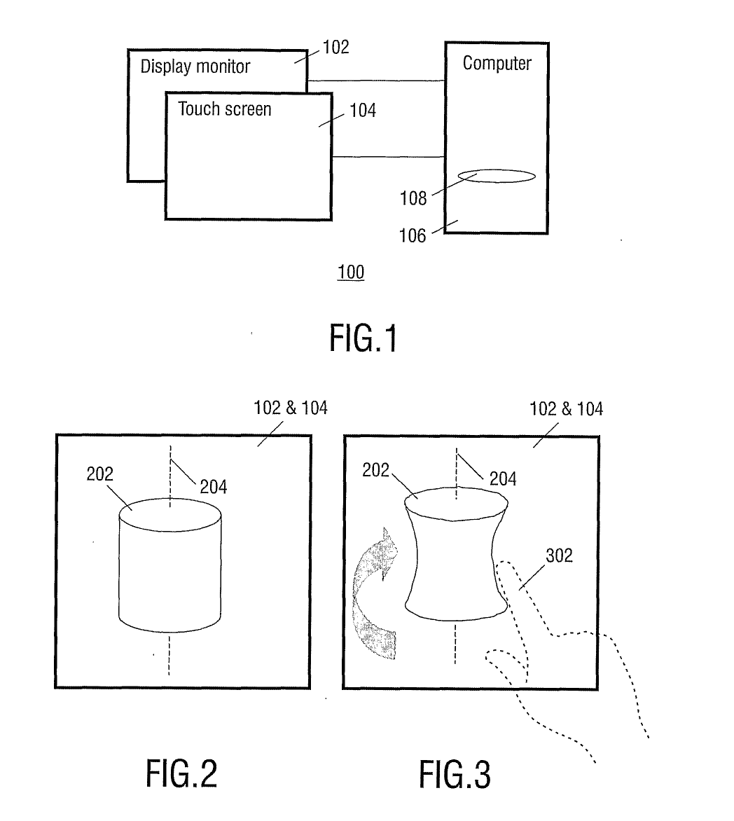

FIGS. 2 and 3 are diagrams illustrating modeling of a virtual object in a virtual pottery application. In FIG. 2 monitor 102 renders a cylindrical object 202. In the pottery application, virtual object 202 is made to rotate around its axis of symmetry 204 that is fixed in (virtual) space. That is, axis 204 is not to be moved as a result of the user's applying a pressure to touch screen 104. In FIG. 3, the user pushes with his/her finger 302 against touch screen 104 at a location coinciding with a location on the surface area of object 202. Touch screen 104 registers the coordinates of the contact with finger 302 as well as its pressure against screen 104. PC 106 receives this data and inputs this to application 108 that generates a modification of the shape of object 202 compliant with the coordinates and pressure level registered. As object 202 is rotating, the modification to the shape now has a rotational symmetry as well.

Note that the extent of the deformation of object 202 as illustrated is of the same order of magnitude as the dimensions finger 302 contacting screen 104. Assume that the user wants to cover the surface of object 202 with depressions with dimensions smaller than that of the characteristic measures of object 202. In this case, the user zooms in on object 202 so that the area of contact between finger 302 and touch screen 104 has the same characteristic dimensions as those of the intended depressions. Accordingly, the scale of the deformation is made to depend on the scale of the object displayed.

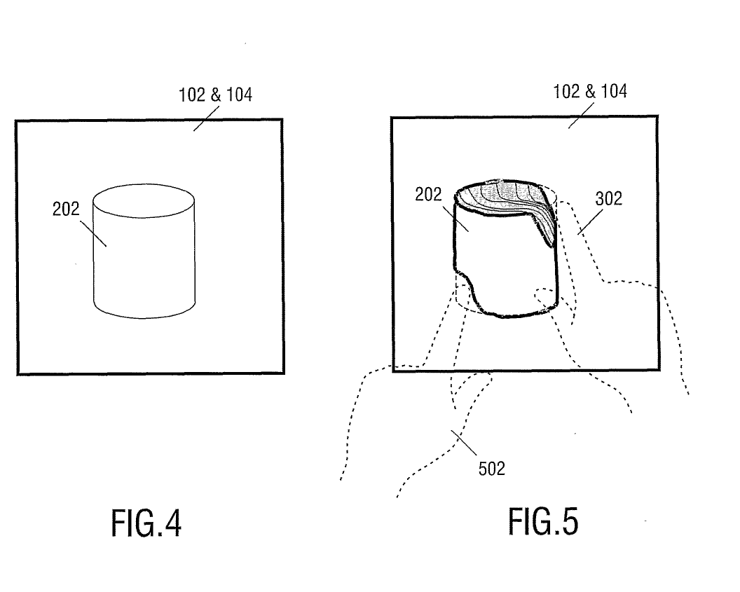

FIGS. 4 and 5 are diagrams illustrating another mode of modeling virtual object 202 rendered at monitor 102. Again, object 202 is not to be moved as an entity across monitor 102, but is only to undergo a deformation as a result of the user's applying a pressure to screen 104 in suitable locations. The user is now applying a pressure to touch screen 104 with both the right hand 302 and the left hand 502 at locations coinciding with the image of object 202 as if to locally squeeze object 202. That is, the locations of contact between hands 302 and 502 as well as a change in the locations while applying pressure define the resulting deformation of object 202. In the example of FIG. 5, object 202 is deformed at the top at the right hand side and at the bottom at the left hand side.

Preferably, system 100 allows the user to move object 202 in its entirety across monitor 102, e.g., to reposition it or to change its orientation with respect to the direction of viewing. For example, monitor 102 can display menu options in an area not visually covering object 202. Alternatively, interaction with touch screen 104 is carried out in such a manner so as to enable system 100 to discriminate between commands to deform object 202 and commands to change the position or orientation of object 202 as a whole. For example, a sweeping movement of the user's hand across screen 104 starting outside of the region occupied by object 202 is interpreted as a command to rotate object 202 in the direction of the sweep around an axis perpendicular to that direction and coinciding with, e.g., a (virtual) center of mass of object 202 that itself remains fixed in the virtual environment. The rotation continues as long as the user is contacting and moving his/her hand.

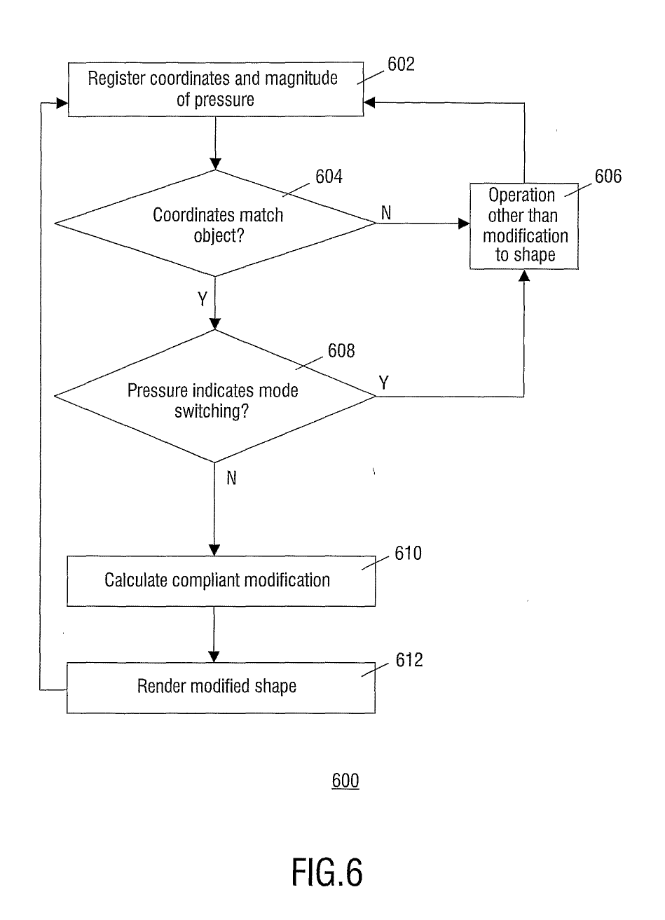

FIG. 6 is a flow diagram illustrating a process 600 in the invention. In a step 602, touch screen 104 supplies data to PC 106 representative of the location of contact and of the contact pressure. In a step 604 it is determined if the location matches a location on a surface of object 202. If there is no match, application 108 interprets the input as a command for an operation other than a modification of the shape of object 202 in an optional step 606. For example, a succession of coordinates, i.e., an ordered set of coordinates, that does not match object 202 is interpreted as a command to shift object 202 in its entirety in the direction of the vector corresponding with the succession. As another example, if there is no match, a pressure increase is interpreted as a zooming in on the image of object 202. A zooming out operation is initiated, e.g., upon a rate of change in pressure above a certain threshold or upon the pressure itself exceeding a specific threshold. Alternatively, or in addition, specific operations other than shape modification may be listed as options in a menu displayed on monitor 102 together with object 202. If the coordinates do match with object 202, an optional step 608 checks if the pressure or changes therein indicate a transition to another operation mode, examples of which have been given above. If there is no mode switching, the modification to the shape of object 202 is determined in a step 610 based on the input of step 602 and the modified shape is rendered in a step 612.

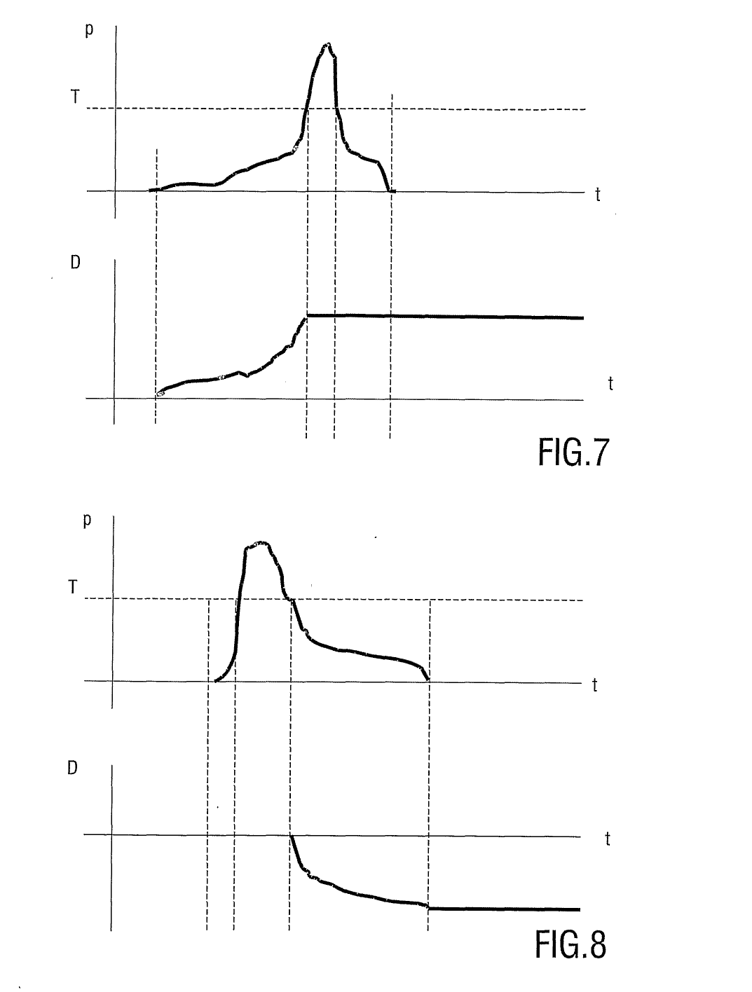

FIGS. 7-9 are diagrams to illustrate relationships between the pressure “p” applied to touch screen 102 and the resulting deformation “D” of object 202 over a period of time “t”. In FIG. 7, system 100 is in a first operational mode, wherein the pressure is increasing over time and the resulting deformation, e.g., the spatial deviation from the original shape is increasing likewise as if object 202 were locally compressed. When the pressure is raised above a threshold T, or when the pressure is raised above threshold T at a rate higher than a certain minimum rate, system 100 interprets this as that the final deformation of object 202 has been reached in this session. The deformation stops and the pressure can be lowered to zero without the deformation changing. Threshold T and the minimum rate are preferably programmable. Note that a pressure whose value stays below the threshold may have deformation effects depending on the material properties programmed. For example, if virtual object 202 is to represent a piece of modeling clay, a decrease of pressure after a raise in pressure will leave the deformation as it was at the instant pressure “p” reached its maximum value (lower than threshold T). If object 202 is to represent a material that is rather elastic or spongy, a decrease in pressure after the pressure has reached a maximum (below threshold T) results in a decrease of the deformation, not necessarily instantly depending on the material properties programmed.

FIG. 8 illustrates a second operational mode of system 100. At the start of the session, pressure “p” is made to increase quickly above threshold T. System 100 interprets this as that the user intends a deformation corresponding to a local expansion, rather than compression of the diagram of FIG. 7. When pressure p is lowered below threshold T, system 100 controls the local expansion of object 202, e.g., as if equilibrium were being conserved all the time between the internal pressure of object 202 being determined by, on the one hand, the material properties of object 202 programmed, and on the other hand the pressure applied by the user through touch screen 104.

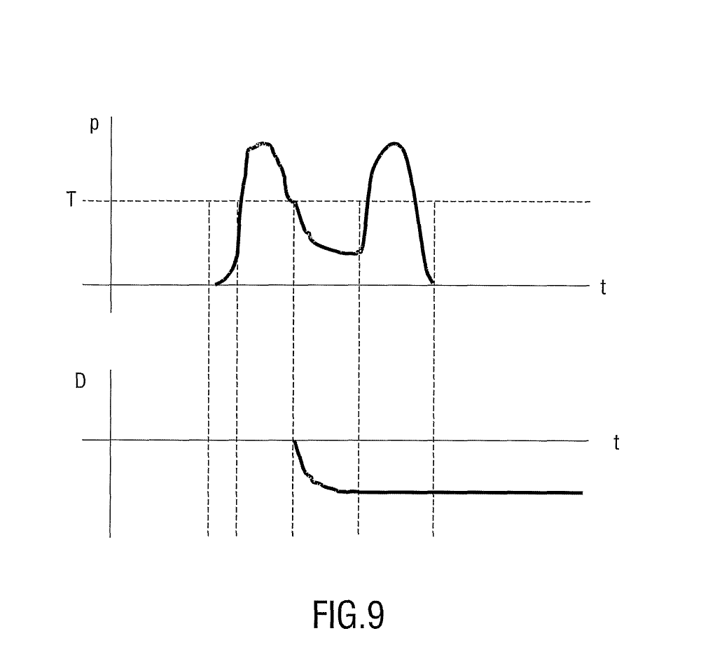

Alternatively, FIG. 9 shows that the local expansion deformation may be terminated when a certain deformation is achieved by means of increasing the pressure with a rate of change above a certain threshold. The deformation then stops and the pressure may be lowered to zero without the deformation changing.

For conserving the continuity of virtual object 202 as rendered during the deformations, see the Jennings document for details.

The invention can be used, e.g., to create a virtual object for aesthetic purposes; as a toy; as an aid for helping to understand the behavior of physical objects with specific or programmable material properties; as a template for a physical model to be made through computer-aided manufacturing; as an application in a computer game to shape the virtual environment or to interact with it and its virtual occupants in operational use; to have fun during uninspiring video conferences by applying touch-induced conformal mappings to the image of the current speaker displayed at one's PC, etc. As to the latter example, preferably there is provided an instant-reset button for returning to the normal viewing mode in order to get rid of too hilarious effects that may interfere with the conferencing, as well as an “undo” button to retrieve the results of the last mapping.

The term “touch screen” as used in this text is also to include graphical tablets, e.g., stylus-operated. What has been discussed above with regard to touch screens that interact with the user's finger is also applicable to graphical tablets.

1. A data processing system with a display monitor for rendering a virtual object, and with a touch screen for enabling a user to interact with the object rendered, wherein the system is operative to enable the user to modify a shape of the object at a first location on the object under control of a magnitude of a pressure registered at a second location on the screen substantially coinciding with the first location when viewed through the screen in operational use of the system.

2. The system of claim 1, wherein a relationship between the magnitude and a modification of the shape is programmable.

3. The system of claim 1, operative to enable to change a scale of the object rendered, wherein a relationship between the magnitude and a modification of the shape depends on the scale of the object rendered.

4. The system of claim 1, having an operational mode wherein the shape responds to an increase in the pressure.

5. The system of claim 1, having a further operational mode wherein the shape responds to a decrease in the pressure.

6. A method of enabling to model a shape of a virtual object rendered on a display monitor having a touch screen, the method comprising enabling to modify the shape at a first location on the object under control of a magnitude of a pressure registered at a second location on the screen substantially coinciding with the first location when viewed through the screen in operational use of the system.

7. The method of claim 6, comprising enabling to program a relationship between the magnitude and a modification of the shape.

8. The method of claim 6, comprising enabling to change a scale of the object rendered, wherein a relationship between the magnitude and a modification of the shape depends on the scale of the object rendered.

9. The method of claim 6, comprising having the shape respond to an increase in the pressure.

10. The method of claim 6, comprising having the shape respond to a decrease in the pressure.

11. Control software for use with a data processing system that has a display monitor for rendering a virtual object, and a touch screen for enabling a user to interact with the object rendered, wherein the control software is operative to enable the user to modify a shape of the object at a first location on the object under control of a magnitude of a pressure registered at a second location on the screen substantially coinciding with the first location when viewed through the screen in operational use of the system.

12. The software of claim 11, wherein a relationship between the magnitude and a modification of the shape is programmable.

13. The software of claim 11, enabling to change a scale of the object rendered, wherein a relationship between the magnitude and a modification of the shape depends on the scale of the object rendered.
